(19) United States
(12) Patent Application Publication
(10) Pub. No.: US 2019/0026231 A1
(43) Pub. Date: Jan. 24, 2019

(54) System Memory Management Unit Architecture For Consolidated Management Of Virtual Machine Stage 1 Address Translations

(71) Applicant: QUALCOMM Incorporated, San Diego, CA (US)

(72) Inventors: Sudeep Ravi KOTTILINGAL, San Diego, CA (US); Samar Asbe, San Diego, CA (US); Vipul Gandhi, San Diego, CA (US)

(21) Appl. No.: 15/658,179

(22) Filed: Jul. 24, 2017

(51) Int. Cl. G06F 12/1009; G06F 12/1027; G06F 9/455

(52) U.S. Cl. CPC G06F 12/1009; G06F 12/1027; G06F 2009/45583; G06F 2212/152; G06F 2212/68; G06F 9/45558

(57) ABSTRACT

Various aspects include computing device methods for managed virtual machine memory access. Various aspects may include receiving a memory access request from a managed virtual machine having a virtual address, retrieving a first physical address for a stage 2 page table for a managing virtual machine, in which the stage 2 page table is stored in a physical memory space allocated to a hypervisor, retrieving a second physical address from an entry of the stage 2 page table for a stage 1 page table for a process executed by the managed virtual machine, in which the second physical address is for a physical memory space allocated to the managing virtual machine and the stage 1 page table is stored in that physical memory space, and retrieving a first intermediate physical address from an entry of the stage 1 page table for a translation of the virtual address.

### BACKGROUND

Virtualization extensions can be architected to support multiple operating systems (OS) and their applications that run in the contexts of independent virtual machines (VMs) on a central processing unit (CPU). Each VM has independent virtual address space that the VM manages and that maps to an intermediate physical address (IPA) space, or stage 1 memory.

A VM's virtual address space is mapped to the VM's IPA space by a set of stage 1 page tables, and the IPA is mapped to the VM's physical address space, or stage 2 memory, by a set of stage 2 page tables. The VM's stage 1 and stage 2 page tables are loaded to the CPU to enable translations between virtual addresses, IPAs, and physical addresses.

For input/output (I/O)/direct memory access (DMA) masters in a system on chip (SoC) that perform work on behalf of a VM, a hypervisor makes a VM's physical address space available to those masters by loading the stage 2 page table to the system memory management unit (SMMU) that provides the same view of the VM's physical address space to a master as viewed by the VM running on the CPU. The VM may provide a contiguous view of the physical address range that is accessible to the masters through stage 1 translations by the SMMU. Each VM manages its address space by managing the stage 1 translations for software processes running on the CPU as well as stage 1 translations on SMMUs for the masters that are working on behalf of the VM. The memory regions used for the stage 1 page tables and the memory regions (data buffers) accessible to the masters are all part of the VM's IPA space and are mapped to the physical memory in the stage 2 page tables for that VM by the hypervisor.

### SUMMARY

Various disclosed aspects may include apparatuses and methods for implementing managed virtual machine memory access on a computing device. Various aspects may include receiving a memory access request from a managed virtual machine having a virtual address, retrieving a first physical address for a stage 2 page table for a managing virtual machine, in which the stage 2 page table for the managing virtual machine is stored in a physical memory space allocated to a hypervisor, retrieving a second physical address from an entry of the stage 2 page table for the managing virtual machine for a translation of a first intermediate physical address for a stage 1 page table for a process executed by the managed virtual machine, in which the second physical address is for a physical memory space allocated to the managing virtual machine and the stage 1 page table for the process executed by the managed virtual machine is stored in the physical memory space allocated to the managing virtual machine, and retrieving a second first intermediate physical address from an entry of the stage 1 page table for the process executed by the managed virtual machine for a translation of the virtual address.

In some aspects, retrieving a second physical address from an entry of the stage 2 page table may include executing a page table walk of the stage 2 page table for the managing virtual machine in the physical memory space allocated to the hypervisor from for the first second physical address, and retrieving a second first intermediate physical address from an entry of the stage 1 page table may include executing a page table walk of the stage 1 page table for the process executed by the managed virtual machine in the physical memory space allocated to the managing virtual machine from for the second first intermediate physical address.

In some aspects, retrieving a first physical address for a stage 2 page table for a managing virtual machine may include retrieving the first physical address from a first register associated with a translation context for the managing virtual machine. Some aspects may further include retrieving a second intermediate physical address for the stage 1 page table for the process executed by the managed virtual machine from a second register associated with the process executed by the managed virtual machine.

Some aspects may further include retrieving a third physical address for a stage 2 page table for the managed virtual machine in which the third physical address is for the physical memory space allocated to the hypervisor and the stage 2 page table for the managed virtual machine is stored in the physical memory space allocated to the hypervisor, executing a page table walk of the stage 2 page table for the managed virtual machine in the physical memory space allocated to the hypervisor from the third for a fourth physical address for a translation of the first intermediate physical address, and retrieving a the fourth physical address from an entry of the stage 2 page table for the managed virtual machine for a translation of the second intermediate physical address.

Some aspects may further include identifying a plurality of translation contexts for translating the virtual address of the memory access request.

In some aspects, identifying a plurality of initial translation contexts may include comparing a stream identifier of the memory access request configured to identify the process executed by the managed virtual machine with a stream identifier stored in a first register configured to store the stream identifier, and identifying a translation context of the managing virtual machine for translating the virtual address to the second intermediate physical address from data stored in a first plurality of registers associated with the first register, in which at least one of the first plurality of registers specifies a virtual machine identifier of the managing virtual machine.

In some aspects, identifying a plurality of initial translation contexts may include identifying a translation context of the managed virtual machine for translating the virtual address to a third physical address from data stored in a second plurality of registers associated with the first register, in which at least one of the second plurality of registers specifies a virtual machine identifier of the managed virtual machine.

Some aspects may further include storing a translation of the virtual address to the second first intermediate physical address to a translation lookaside buffer, and associating the stored translation with a virtual machine identifier of the managing managed virtual machine in the translation lookaside buffer.

Various aspects may further include a computing device having a physical memory having a physical memory space allocated to a hypervisor and a physical memory space allocated to a managing virtual machine, and a processor configured to execute the managing virtual machine and a managed virtual machine, and to perform operations of any of the methods summarized above. Various aspects may further include a computing device having means for performing functions of any of the methods summarized above. Various aspects may further include a non-transitory processor-readable medium on which are stored processor-executable instructions configured to cause a processor of a computing device to perform operations of any of the methods summarized above.

### BRIEF DESCRIPTION OF THE DRAWINGS

The accompanying drawings, which are incorporated herein and constitute part of this specification, illustrate example aspects of various aspects, and together with the general description given above and the detailed description given below, serve to explain the features of the claims.

FIG. 1 is a component block diagram illustrating a computing device suitable for implementing various aspects.

FIG. 2 is a component block diagram illustrating an example multicore processor suitable for implementing various aspects.

FIG. 3 is a block diagram illustrating an example heterogeneous computing device suitable for implementing various aspects.

FIG. 4 is a block diagram illustrating an example heterogeneous computing device suitable for implementing various aspects.

FIG. 5 is a block diagram illustrating an example of stages of memory virtualization for multiple virtual machines for implementing various aspects.

FIG. 6 is a component interaction flow diagram illustrating an example of an operation flow for managed virtual machine memory access for implementing various aspects.

FIGS. 7A-7C are block diagrams illustrating examples of system memory management unit registers for implementing various aspects.

FIG. 8 is a process flow diagram illustrating a method for implementing managed virtual machine memory access according to an aspect.

FIG. 9 is a process flow diagram illustrating a method for implementing stage 1 memory translation for managed virtual machine memory access according to an aspect.

FIG. 10 a process flow diagram illustrating a method for implementing stage 2 memory translation for managed virtual machine memory access according to an aspect.

FIG. 11 is a relational diagram illustrating translations between addresses in a translation lookaside buffer and tagging of the translations of the translation lookaside buffer for implementing various aspects.

FIG. 12 is a component block diagram illustrating an example mobile computing device suitable for use with the various aspects.

FIG. 13 is a component block diagram illustrating an example mobile computing device suitable for use with the various aspects.

FIG. 14 is a component block diagram illustrating an example server suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various aspects may include methods, and computing devices implementing such methods for implementing a managing virtual machine (VM) to implement stage 1 memory address translation for a virtual address (VA) of a managed VM. The apparatus and methods of the various aspects may include allowing a managing VM (e.g., a Rich OS) to manage memory (e.g., stage 1 memory) of managed VMs, and expanding the architecture beyond virtualization-only use cases. The apparatus and methods of various aspects may include using a memory management and system memory management unit (SMMU) infrastructure for a managing VM to implement stage 1 memory management for managed VMs by using VM identifiers known to the SMMU to route managed VM stage 1 memory address translation operations to the managing VM's stage 2 memory in order to retrieve managed VM stage 1 memory address translations

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

The existing model of multiple VMs managing their respective address spaces works when a hypervisor is designed for virtualization related use cases. However, when a hypervisor is designed and deployed with the responsibility of managing SoC security, it may be advantageous for a managing VM (even though it may be an un-trusted VM) to act as a managing entity for other security domains in the system. For example, a managing VM may be a Rich OS, in which case advantages may include leveraging the Rich OS's memory manager, allocator, and SMMU driver to manage memory for other VMs/domains. This may lead to a much simpler system designed specifically geared towards managing SoC security.

In SoC security directed situations, it may be overkill to have separate VMs executing memory management (including stage 1 memory translations) for other SoC domains. Even in cases that have separate VMs running on a CPU, it may be advantageous to allow a managing VM to manage the SMMUs of various input/output (I/O) devices on behalf of the other VMs. Presently, there are architectural limitations preventing one VM managing stage 1 memory of other VMs.

A hardware solution to the architecture restrictions may involve configuring a managing VM to use its memory management infrastructure so that the managing VM can efficiently perform the memory management tasks of/for other VMs. For example, a Rich OS typically includes a memory management driver and an SMMU driver to manage stage 1 memory for all masters that perform work on behalf of the Rich OS. In various aspects, the managing VM and its memory management infrastructure may be configured to use its memory management infrastructure so that the managing VM can also manage the stage 1 memory of managed VMs, present a virtual contiguous address range (e.g., stage 1 memory or intermediate physical address (IPA) space) for I/O devices to work on, and handle memory fragmentation using stage 1 translations.

Typically, a stage 2 nesting rule may provide that the stage 1 page table can be part of the VM's IPA space and mapped in the stage 2 memory of that VM. In various aspects, a separate VM identifier (VMID) and a separate stage 2 nesting rule may be associated with each stage 1 context bank for a page table walker. This rule may be separate from the VMID and stage 2 nesting rule, which is applicable for memory regions that are accessed from the I/O device. The IPAs of the memory accesses from the I/O device can continue to be translated from the stage 2 physical memory of the managed VM itself, but the IPAs of stage 1 page tables may be translated by the page table translations of the managing VM's stage 2 physical memory space.

The separate stage 2 nesting rule may be implemented for instances in which the hypervisor needs to manage multiple SoC domains with the primary objective of maintaining security. On mobile device SoCs, there are typically different security domains/VMs on the SoC that are managed by a hypervisor. On such SoCs, leveraging the managing VM (e.g., Rich OS kernel) infrastructure of memory and SMMU management to also manage the memory for other VM/domains may reduce the overhead of creating VMs with similar levels of complexity that run on the CPU. In an example, separate stage 2 nesting may be implemented for multimedia content protection related use cases in which page shuffling attacks through stage 1 memory management are not relevant or of concern.

To implement separate stage 2 nesting and separate VMIDs, fields in an SMMU global register space may be added so that stage 1 page table walks may be routed to the managing VM's stage 2 context bank, as opposed to being routed to the stage 2 context bank of the managed domain as in the case of data accesses from I/O devices. A new page table walker VMID and a stage 2 context bank index for stage 1 page table walks may be added so that these fields can be used to point the stage 1 page table walks to appropriate stage 2 context banks. Translation lookaside buffers (TLB) for page table walks may be tagged with an appropriate VMID of the managing VM to take advantage of TLB caching. A VMID field in a configuration attribute register of the stage 1 context bank may be used for data accesses from I/O devices.

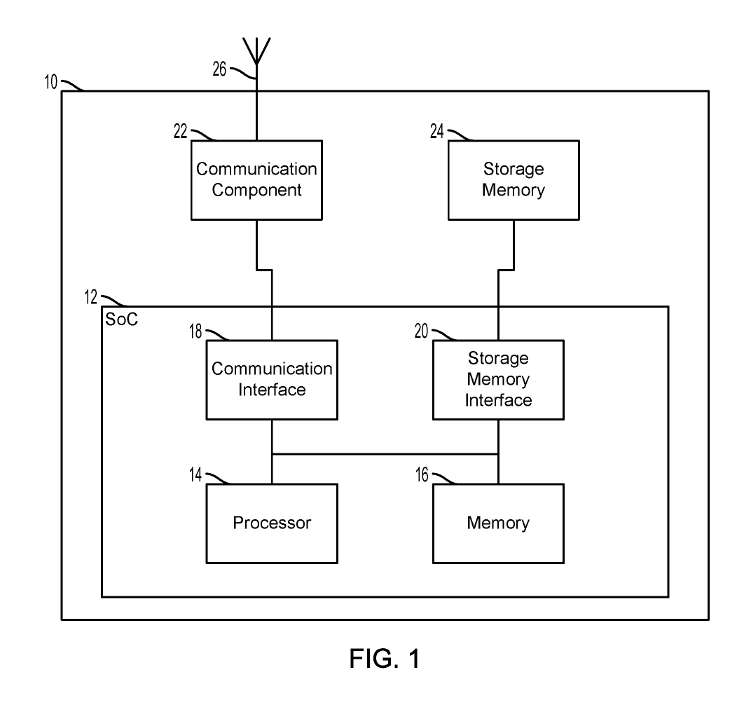

FIG. 1 illustrates a system including a computing device 10 suitable for use with the various aspects. The computing device 10 may include a system-on-chip (SoC) 12 with a processor 14, a memory 16, a communication interface 18, and a storage memory interface 20. The computing device 10 may further include a communication component 22, such as a wired or wireless modem, a storage memory 24, and an antenna 26 for establishing a wireless communication link. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), a subsystem processor of specific components of the computing device, such as an image processor for a camera subsystem or a display processor for a display, an auxiliary processor, a single-core processor, and a multicore processor. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

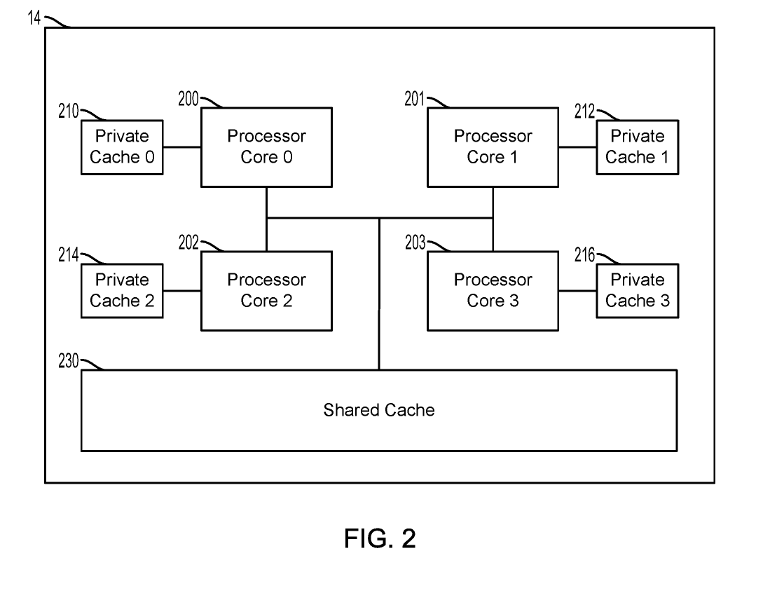

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multicore processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, or cache memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a “miss,” because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 in response to execution of a function may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an aspect of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be arranged differently and/or combined while still serving the functions of the various aspects. The computing device 10 may not be limited to one of each of the components, and multiple instances of each component may be included in various configurations of the computing device 10.

FIG. 2 illustrates a multicore processor suitable for implementing an aspect. The multicore processor 14 may include multiple processor types, including, for example, a CPU and various hardware accelerators, including for example, a GPU, a DSP, an APU, subsystem processor, etc. The multicore processor 14 may also include a custom hardware accelerator, which may include custom processing hardware and/or general purpose hardware configured to implement a specialized set of functions.

The multicore processor may have a plurality of homogeneous or heterogeneous processor cores 200, 201, 202, 203. A homogeneous multicore processor may include a plurality of homogeneous processor cores. The processor cores 200, 201, 202, 203 may be homogeneous in that, the processor cores 200, 201, 202, 203 of the multicore processor 14 may be configured for the same purpose and have the same or similar performance characteristics. For example, the multicore processor 14 may be a general purpose processor, and the processor cores 200, 201, 202, 203 may be homogeneous general purpose processor cores. The multicore processor 14 may be a GPU or a DSP, and the processor cores 200, 201, 202, 203 may be homogeneous graphics processor cores or digital signal processor cores, respectively. The multicore processor 14 may be a custom hardware accelerator with homogeneous processor cores 200, 201, 202, 203.

A heterogeneous multicore processor may include a plurality of heterogeneous processor cores. The processor cores 200, 201, 202, 203 may be heterogeneous in that the processor cores 200, 201, 202, 203 of the multicore processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar aspects, an SoC (for example, SoC 12 of FIG. 1) may include any number of homogeneous or heterogeneous multicore processors 14. In various aspects, not all off the processor cores 200, 201, 202, 203 need to be heterogeneous processor cores, as a heterogeneous multicore processor may include any combination of processor cores 200, 201, 202, 203 including at least one heterogeneous processor core.

Each of the processor cores 200, 201, 202, 203 of a multicore processor 14 may be designated a private cache 210, 212, 214, 216 that may be dedicated for read and/or write access by a designated processor core 200, 201, 202, 203. The private cache 210, 212, 214, 216 may store data and/or instructions, and make the stored data and/or instructions available to the processor cores 200, 201, 202, 203, to which the private cache 210, 212, 214, 216 is dedicated, for use in execution by the processor cores 200, 201, 202, 203. The private cache 210, 212, 214, 216 may include volatile memory as described herein with reference to memory 16 of FIG. 1.

The multicore processor 14 may further include a shared cache 230 that may be configured to read and/or write access by the processor cores 200, 201, 202, 203. The private cache 210, 212, 214, 216 may store data and/or instructions, and make the stored data and/or instructions available to the processor cores 200, 201, 202, 203, for use in execution by the processor cores 200, 201, 202, 203. The shared cache 230 may also function as a buffer for data and/or instructions input to and/or output from the multicore processor 14. The shared cache 230 may include volatile memory as described herein with reference to memory 16 of FIG. 1.

In the example illustrated in FIG. 2, the multicore processor 14 includes four processor cores 200, 201, 202, 203 (i.e., processor core 0, processor core 1, processor core 2, and processor core 3). In the example, each processor core 200, 201, 202, 203 is designated a respective private cache 210, 212, 214, 216 (i.e., processor core 0 and private cache 0, processor core 1 and private cache 1, processor core 2 and private cache 2, and processor core 3 and private cache 3). For ease of explanation, the examples herein may refer to the four processor cores 200, 201, 202, 203 and the four private caches 210, 212, 214, 216 illustrated in FIG. 2. However, the four processor cores 200, 201, 202, 203 and the four private caches 210, 212, 214, 216 illustrated in FIG. 2 and described herein are merely provided as an example and in no way are meant to limit the various aspects to a four-core processor system with four designated private caches. The computing device 10, the SoC 12, or the multicore processor 14 may individually or in combination include fewer or more than the four processor cores 200, 201, 202, 203 and private caches 210, 212, 214, 216 illustrated and described herein. For ease of reference, the terms “hardware accelerator,” “custom hardware accelerator,” “multicore processor,” “processor,” and “processor core” may be used interchangeably herein.

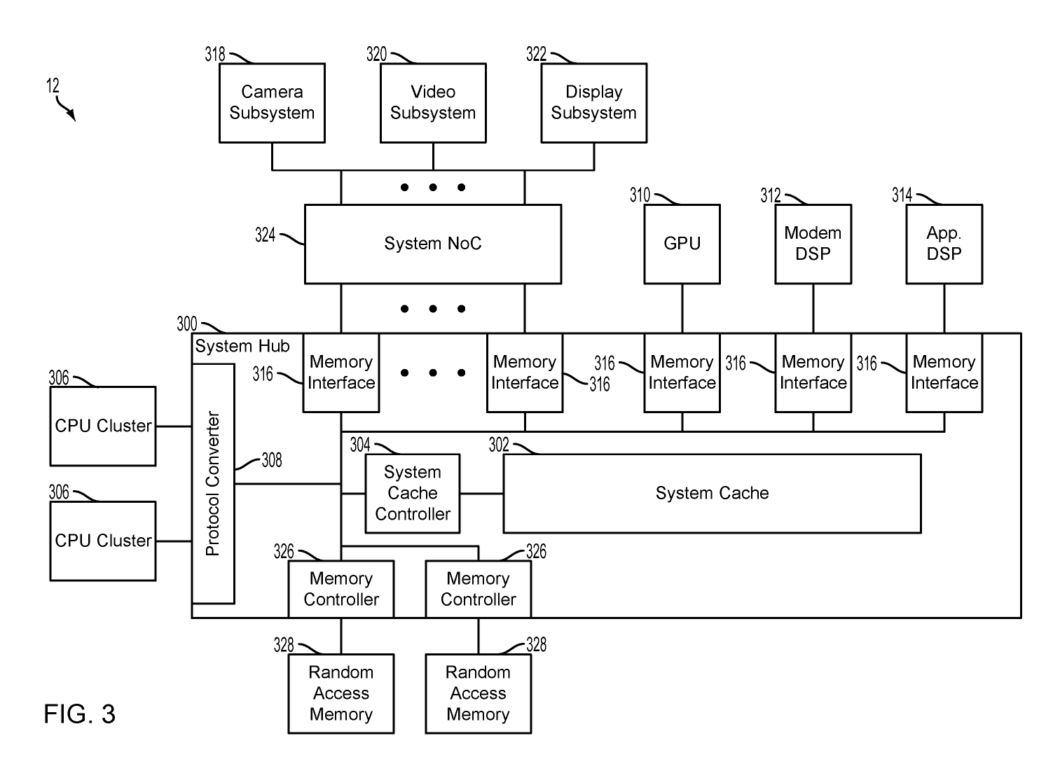

FIG. 3 illustrates a computing device with multiple I/O devices suitable for implementing an aspect. With reference to FIGS. 1-3, the SoC 12 may include a variety of components as described above. Some such components and additional components may be employed to implement SMMU architecture and operations for managing VM stage 1 address translations for a managed VM (described further herein). For example, an SoC 12 configured to implement managing VM stage 1 address translations for a managed VM may include various communication components configured to communicatively connect the components of the SoC 12 that may transmit, receive, and share data. The communication components may include a system hub 300, a protocol converter 308, and a system network on chip (NoC) 324. The communication components may facilitate communication between I/O devices, such as processors (e.g., processor 14 in FIGS. 1 and 2) in CPU clusters 306 and various subsystems, such as camera, video, and display subsystems 318, 320, 322, and may also include other specialized processors such as a GPU 310, a modem DSP 312, an application DSP 314, and other hardware accelerators. The communication components may facilitate communication between the I/O devices and various memory devices, including a system cache 302, a random access memory (RAM) 328, various memories included in the CPU clusters 306 and the various subsystems 318, 320, 322, such as caches (e.g., dedicated cache memories 210, 212, 214, 216 and shared cache memory 230 in FIG. 2). Various memory control devices, such as a system cache controller 304, a memory interface 316, and a memory controller 326, may be configured to control access to the various memories by the I/O devices and implement operations for the various memories, which may be requested by the I/O devices.

The descriptions herein of the illustrated SoC 12 and its various components are only meant to be exemplary and in no way limiting. Several of the components of the illustrated example SoC 12 may be variably configured, combined, and separated. Several of the components may be included in greater or fewer numbers, and may be located and connected differently within the SoC 12 or separate from the SoC 12. Similarly, numerous other components, such as other memories, processors, subsystems, interfaces, and controllers, may be included in the SoC 12 and in communication with the system cache controller 304 in order to access the system cache 302.

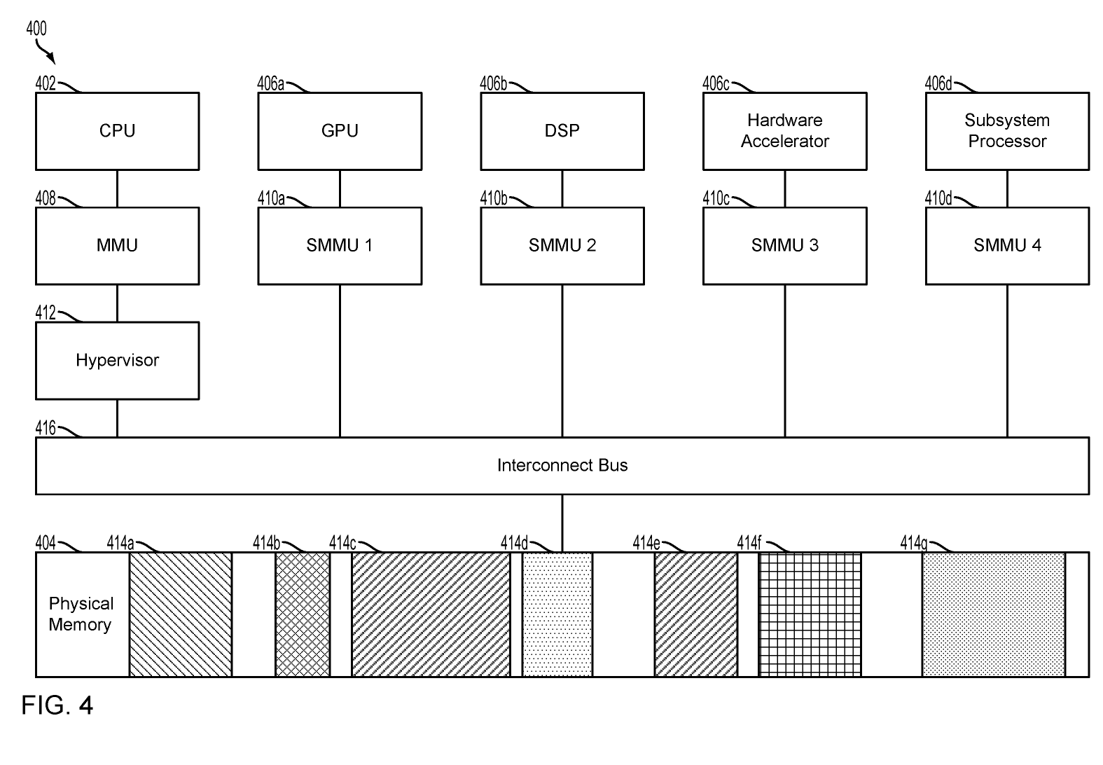

FIG. 4 illustrates an example aspect of a heterogeneous computing device. A heterogeneous computing device 400 (e.g., the computing device 10 in FIG. 1) may include at least two, but up to any integer number “N” processing devices (e.g., processor 14 in FIGS. 1 and 2); for example, processing device (e.g., CPU) 402, hardware accelerator (e.g., GPU) 406a, hardware accelerator (e.g., DSP) 406b, custom hardware accelerator 406c, and/or subsystem processor 406d. Each processing device 402, 406a, 406b, 406c, 406d may be associated with a memory management unit configured to receive memory access requests and responses to and from various physical memories 404 (e.g., memory 16 and 24 in FIG. 1, and system cache 302 and RAM 328 in FIG. 3), to translate between virtual memory addresses recognized by the processing device 402, 406a, 406b, 406c, 406d and intermediate physical memory addresses of associated with the physical memories 404, and to control the flow of and to direct the memory access requests and responses to their destinations. For example, the CPU 402 may be associated with the memory management unit (MMU) 408, the GPU 406a may be associated with an SMMU 410a (SMMU1), the DSP 406b may be associated with an SMMU 410b (SMMU 2), the custom hardware accelerator 406c may be associated with an SMMU 410c (SMMU 3), and the subsystem processor 406d may be associated with an SMMU 410d (SMMU 4). Each processing device 402, 406a, 406b, 406c, 406d may also be associated with a hypervisor (or virtual machine manager) 408. The hypervisor 412 may be implemented as shared by processing devices 402, 406a, 406b, 406c, 406d and/or individually for a processing device 402, 406a, 406b, 406c, 406d. In various aspects, the memory management units 408, 410a, 410b, 410c, 410d and hypervisor 412 may be implemented as hardware components separate from or integrated with the processing devices 402, 406a, 406b, 406c, 406d.

The processing devices 402, 406a, 406b, 406c, 406d, memory management units 408, 410a, 410b, 410c, 410d, and hypervisor 412 may be communicatively connected to the other processing devices 402, 406a, 406b, 406c, 406d, memory management units 408, 410a, 410b, 410c, 410d by an interconnect bus 416, and hypervisor 412. The processing devices 402, 406a, 406b, 406c, 406d, memory management units 408, 410a, 410b, 410c, 410d, and hypervisor 412 may communicate via the interconnect bus by sending and receiving data, instructions, and other signals. The interconnect bus 416 may further communicatively connect the processing devices 402, 406a, 406b, 406c, 406d, memory management units 408, 410a, 410b, 410c, 410d, and hypervisor 412 to a physical memory 404.

The physical memory 404 may be configured so that multiple partitions 414a, 414b, 414c, 414d, 414e, 414f, 414g of the physical memory 404 may be configured for exclusive or shared access by the processing devices 402, 406a, 406b, 406c, 406d and the hypervisor 412. In various aspects, more than one partition 414a, 414b, 414c, 414d, 414e, 414f, 414g (e.g., partitions 414c and 414e) may be allocated to a processing device 402, 406a, 406b, 406c, 406d. The partitions 414a, 414b, 414c, 414d, 414e, 414f, 414g may store data, code, and/or page tables for use by the processing devices 402, 406a, 406b, 406c, 406d to execute program processes and by the hypervisor to aid in and implement address translations in support of the execution of the program processes. The physical memory 404 may store page tables having data for translating between virtual address used by the processing devices 402, 406a, 406b, 406c, 406d and physical addresses of the memories of the heterogeneous computing device 300, including the physical memory 404. In various aspects, at least one of the partitions 414a, 414b, 414c, 414d, 414e, 414f, 414g (e.g., partition 414b) may be allocated to a managing virtual machine running on one of the processing devices 402, 406a, 406b, 406c, 406d, such as the CPU 402 for storage of stage 1 page tables (storing virtual address to intermediate physical address translations) of managed virtual machines for executing functions for various I/O devices (e.g., I/O devices 306, 310, 312, 314, 318, 320, 322 in FIG. 3, and processing devices 402, 406a, 406b, 406c, 406d). In various aspects, at least one of the partitions 414a, 414b, 414c, 414d, 414e, 414f, 414g (e.g., partition 414f) may be allocated to the hypervisor 412 for storage of stage 2 (intermediate physical address to physical) page tables of the managing virtual machine and managed virtual machines.

FIG. 4 illustrates a non-limiting example of a heterogeneous computing device 400. The example heterogeneous computing device 400 illustrated and described herein is meant to be non-limiting. A heterogeneous computing device 400 may include any number and/or combination of processing devices, memory management units, memories, interconnects, and connections between such components. In various aspects, any combination of the components of a heterogeneous computing device may be combined or separated and included as part of or distributed over multiple SoCs (e.g., SoC 12 in FIGS. 1 and 3) which may be communicatively connected via the interconnect 416 or extensions of the interconnect 416.

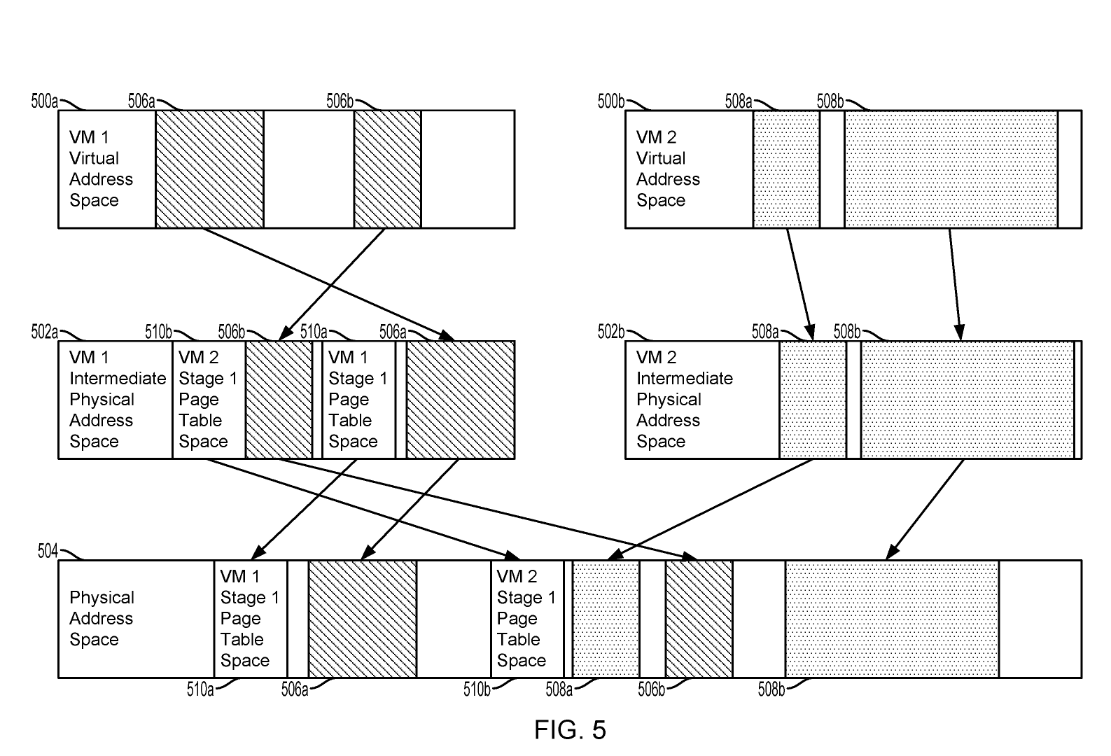

Various aspects are described with reference to FIGS. 5-10 refer to example hardware components described with reference to FIGS. 1-4. The following references to combinations of hardware components are in no way limiting to the number or type processors, hardware accelerators, memory management units, and/or hypervisors that may be included as hardware components for implementing the various aspects described herein. Various aspects may be implemented using any combination of components having two or more processing devices.

FIG. 5 illustrates an example of memory virtualization for multiple virtual machines. In various aspects, a physical memory (e.g., memory 16 and 24 in FIG. 1, system cache 302 and RAM 328 in FIG. 3, and physical memory 404 in FIG. 4) may include a physical address space 504 accessible by virtual machines (e.g., VM1 and VM2), memory management units (e.g., MMUs and SMMUs, such as memory management units 408, 410a, 410b, 410c, 410d in FIG. 4), and hypervisors (e.g., hypervisor 412 in FIG. 4). The physical address space 504 may store data, code, and/or page tables for use by the virtual machines in executing program processes. Partitions 506a, 506b, 508a, 508b, 510a, 510b of the physical address space 504 may be stored in various manners, including in noncontiguous locations in the physical address space 504.

In various aspects, the physical address space 504 accessible by each virtual machine may be virtualized as an intermediate physical address space 502a, 502b. The intermediate physical address space 502a, 502b may be addressed using intermediate physical addresses that may be translated to the corresponding physical addresses of the physical address space 504. For example, the intermediate physical address space 502a may be allocated to the VM 1, which in this example may be the managing virtual machine.

In the physical address space 504, partitions 506a, 506b, 510a, 510b may be allocated for access by the VM 1. Since the VM 1 is the managing virtual machine in this example, the VM 1 may be allocated partitions 506a, 506b storing data and/or code for executing program processes and partitions 510a, 510b storing a VM 1 stage 1 page table and a VM 2 stage 1 page table. The intermediate physical address space 502a allocated to the VM 1 may be configured to represent a view of the partitions 506a, 506b, 510a, 510b allocated to the VM 1 in the physical address space 504 by using intermediate physical address for the partitions 506a, 506b, 510a, 510b in the intermediate physical address space 502a that translate to the physical addresses of the partitions 506a, 506b, 510a, 510b in the physical address space 504.

In a similar example, the intermediate physical address space 502b may be allocated to the VM 2, which in this example may be the managed virtual machine. In the physical address space 504, partitions 508a, 508b may be allocated for access by the VM 2. Since the VM 2 is the managed virtual machine in this example, the VM 2 may be allocated partitions 508a, 508b storing data and/or code for executing program processes and may not be allocated partitions 510a, 510b storing a VM 1 stage 1 page table and a VM 2 stage 1 page table. The intermediate physical address space 502b allocated to the VM 2 may be configured to represent a view of the partitions 508a, 508b allocated to the VM 2 in the physical address space 504 by using intermediate physical address for the partitions 508a, 508b, in the intermediate physical address space 502b that translate to the physical addresses of the partitions 508a, 508b in the physical address space 504.

Another layer of virtualization of the physical address space 504 may be implemented as a virtual address space 500a, 500b. The virtualization of the physical address space 504 implemented by the virtual address space 500a, 500b may be indirect as compared with the intermediate address space 502a, 502b, as the virtual address space 500a, 500b may be a virtualization of the intermediate address space 502a, 502b. Each virtual address space 500a, 500b may be allocated for access by a virtual machine and configured to provide a virtualized view of the corresponding intermediate physical address space 502a, 502b to the corresponding virtual machine. The virtual address space 500a, 500b may be addressed using virtual addresses that may be translated to the corresponding intermediate physical addresses of the physical address space 502a, 502b. For example, the virtual address space 500a may be allocated to the VM 1. The virtual address space 500a may be configured to represent a view of the partitions 506a, 506b allocated to the VM 1 in the intermediate physical address space 502a and the physical address space 504 by using virtual address for the partitions 506a, 506b in the virtual address space 500a that translate to the intermediate physical addresses of the partitions 506a, 506b in the intermediate physical address space 502a.

In a similar example, the virtual address space 500b may be allocated to the VM 2. The virtual address space 500b allocated to the VM 2 may be configured to represent a view of the partitions 508a, 508b allocated to the VM 2 in the physical address space 504 by using virtual address for the partitions 508a, 508b, in the virtual address space 500b that translate to the intermediate physical addresses of the partitions 508a, 508b in the intermediate physical address space 502b.

For a managed virtual machine access to the data and/or code stored in the partitions 508a, 508b in the physical address space 504, the VM 2 (the managed virtual machine) may issue a memory access request, such as a read or write request for the data at a virtual address in the virtual address space 500b. For a self-managed or an independent virtual machine virtual machine access, the VM 2 may manage the stage 1 translation of the virtual address to an intermediate physical address by accessing the VM 2 stage 1 page table in the physical address space 504 via the intermediate physical address space 502b allocated to the VM 2. In various aspects, for a manage virtual machine access, the VM 1 may take over the management of the stage 1 translation for the VM 2's memory access request. The VM 1 may access the VM 2 stage 1 page table in the physical address space 504 via the intermediate physical address space 502a allocated to the VM 1. Continuing with the example in FIG. 5, the VM 2 stage 1 page table may be located in a partition 510b of the physical address space 504 that is allocated to the VM 1. The intermediate physical address space 502a may include a representation of the partition 510b at an intermediate physical address that may translate to a physical address of the partition 510b in the physical address space. Takeover by the VM 1 of the stage 1 translation for the memory access request of the VM 2 is described further herein.

Using the intermediate physical address in intermediate physical address space 502b translated by the VM 1 managed stage 1 translation of the virtual address of the VM 2 memory access request, the hypervisor may translate the intermediate physical address to a corresponding physical address in the physical address space 504. The data and/or code at the physical address may be returned and/or modified according the memory access request of the VM 2.

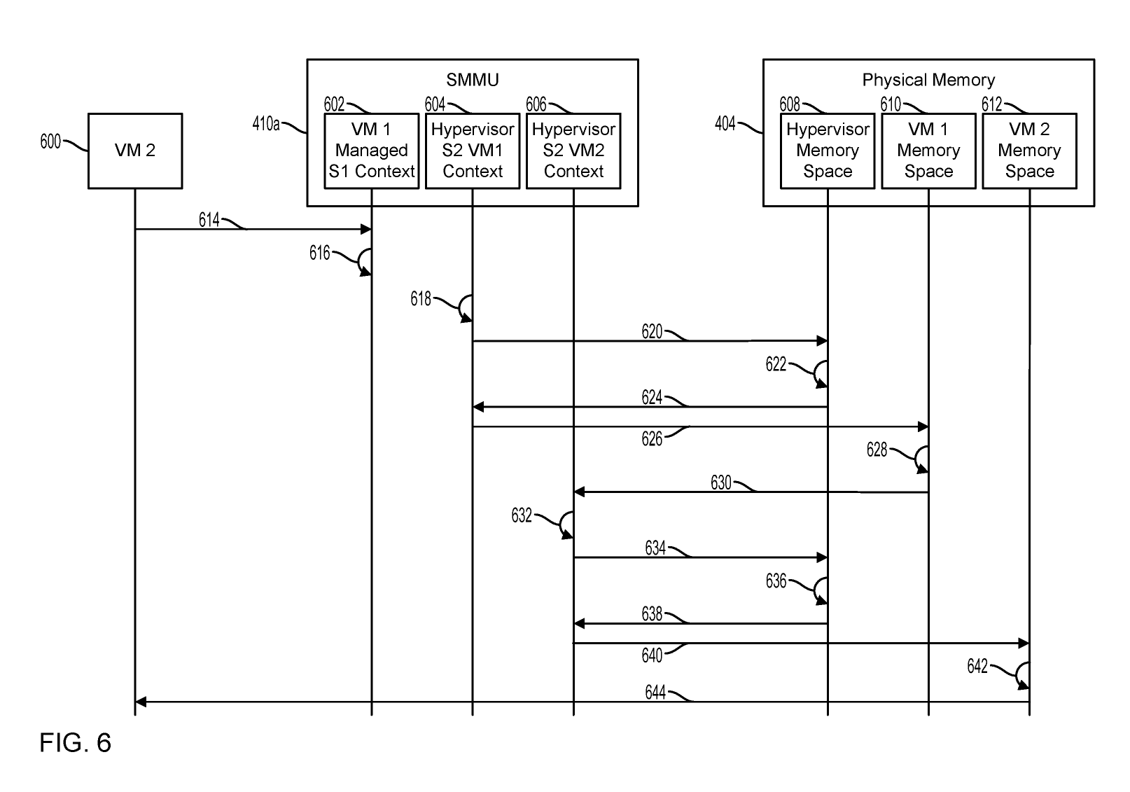

FIG. 6 illustrates an example of operations and data flows for managed virtual machine memory accesses implementing an aspect. The example illustrated in FIG. 6 relates to the structure of the heterogeneous computing device 400 described with reference to FIG. 4. The SMMU 410a and the physical memory 404 are used as examples for ease of explanation and brevity, but are not meant to limit the number and/or types of memory management units (e.g., memory management units 408, 410a, 410b, 410c, 410d in FIG. 4) or memories (e.g., memory 16 and 24 in FIG. 1, system cache 302 and RAM 328 in FIG. 3, and physical memory 404 in FIG. 4). The VM 2 600 (managed virtual machine) may be executed by any of the I/O devices (e.g., processor 14 in FIGS. 1 and 2, I/O devices 306, 310, 312, 314, 318, 320, 322 in FIG. 3, and I/processing devices 402, 406a, 406b, 406c, 406d) in FIG. 4, and processing devices 402, 406a, 406b, 406c, 406d). Further the order of the operations 600-644 is used as an example for ease of explanation and brevity, but is not meant to limit the possible order of execution of the operations 600-644 as several of the operations 600-644 may be implemented in parallel and in other orders.

In the operations and data flows for managed virtual machine memory access, the VM 2 600 may issue a memory access request 614, such as a read or write request, for a virtual address of a virtual address space (e.g., virtual address space 500b in FIG. 5) allocated to the VM 2 600. The SMMU 410a, which may be associated with an I/O device executing processes of/for the VM 2 600, may receive the memory access request 614.

The SMMU 410a may contain multiple contexts for memory address translation. For example, the SMMU 410a may contain a memory address translation context of the VM 1 (managing virtual machine) managed stage 1 (S1) translation context 602 of the VM 2 virtual addresses. The SMMU 410a, using the VM 1 managed stage 1 translation context 602, may retrieve 616 an intermediate physical address for a base address of a stage 1 page table for the processes executed by the VM 2. In various aspects, the intermediate physical address for the base address of a stage 1 page table may be stored in a register accessible by the SMMU 410a and associated with an identifier of the processes, such as a stream identifier (ID), received as part of the memory access request.

Since the SMMU 410a may use the VM 1 managed stage 1 translation context 602, the SMMU 410a may use a corresponding hypervisor context, such as the hypervisor stage 2 (S2) VM 1 context 604, to execute stage 2 translations in the VM 1 context. The SMMU 410a, using the hypervisor stage 2 VM 1 context 604, may retrieve 618 a physical address for a base address of a stage 2 page table for the VM 1. In various aspects, the register storing physical address for the base address of the stage 2 page table may be associated with the register storing the intermediate physical address for the base address of the stage 1 page table, with the stream identifier, with the VM 1, with a translation context for the VM 1, and/or may be a designated register.

The SMMU 410a, using the hypervisor stage 2 VM 1 context 604, may issue a memory read access request 620, such as a read access request, to the physical memory 404, and particularly to the physical address in a hypervisor memory space 608 of the physical memory 404. The read access request 620 may be directed to the physical address for the base address of the stage 2 page table of the VM 1. The read access request 620 may trigger a page table walk 622 in the hypervisor memory space 608 of the stage 2 page table of the VM 1 for the page table entry for the translation of the intermediate physical address for the base address of the stage 1 page table for the VM 2 to a physical address in the VM 1 memory space 610 in the physical memory 404 for the address of the stage 1 page table for the VM 2.

The physical memory 404 may return, and the SMMU 410a, using the hypervisor stage 2 VM 1 context 604, may receive 624 the physical address for the base address of the stage 1 page table for the VM 2. The SMMU 410a, using the hypervisor stage 2 VM 1 context 604, may issue 626 a memory access request, such as a read access request, to the physical memory 404, and particularly to the physical address in the VM 1 memory space 610 of the physical memory 404. The read access request may be directed to the physical address for the base address of the stage 1 page table of the VM 2. The read access request may trigger a page table walk 628 in the VM 1 memory space 610 of the stage 1 page table of the VM 2 for the page table entry for the translation of the virtual address of the VM 2's memory access request to an intermediate physical address in a VM 2 intermediate physical memory space.

The shared physical 404 may return, and the SMMU 410a, using a hypervisor stage 2 VM 2 context 606, may receive 630 the intermediate physical address for VM 2's memory access request. The SMMU 410a, using the hypervisor stage 2 VM 2 context 606, may retrieve 632 a physical address for a base address of a stage 2 page table for the processes executed by the VM 2. In various aspects, the physical address for the base address of a stage 2 page table may be stored in a register accessible by the SMMU 410a and associated with an identifier of the processes, such as a stream identifier (ID), received as part of the memory access request. In various aspects, the physical address for the base address of the stage 2 page table may be stored in a register accessible by the SMMU 410a. In various aspects, the register storing the physical address for the base address of the stage 2 page table may be associated with register storing the intermediate physical address for the base address of the stage 1 page table for the VM 1, with the stream identifier, with the VM 2, with a translation context for the VM 2, and/or may be a designated register.

The SMMU 410a, using the hypervisor stage 2 VM 2 context 606, may issue a memory access request 634, such as a read access request, to the physical memory 404, and particularly to the physical address in the hypervisor memory space 608 of the physical memory 404. The read access request 634 may be directed to the physical address for the base address of the stage 2 page table of the VM 2. The read access request 634 may trigger a page table walk 636 in the hypervisor memory space 608 of the stage 2 page table of the VM 2 for the page table entry for the translation of the intermediate physical address of the VM 2's memory access request to a physical address in a VM 2 memory space 612 of the physical memory 404.

The physical memory 404 may return, and the SMMU 410a, using a hypervisor stage 2 VM 2 context 606, may receive 638 the physical address for VM 2's memory access request. The SMMU 410a, using the hypervisor stage 2 VM 2 context 606, may issue a memory access request 640, such as a read or write access request, to the physical memory 404, and particularly to the physical address in the VM 2 memory space 612 of the physical memory 404. The shared memory may retrieve or modify 642 the data at the physical address in the VM 2 memory space 612, and/or return 644 the data at the physical address in the VM 2 memory space 612.

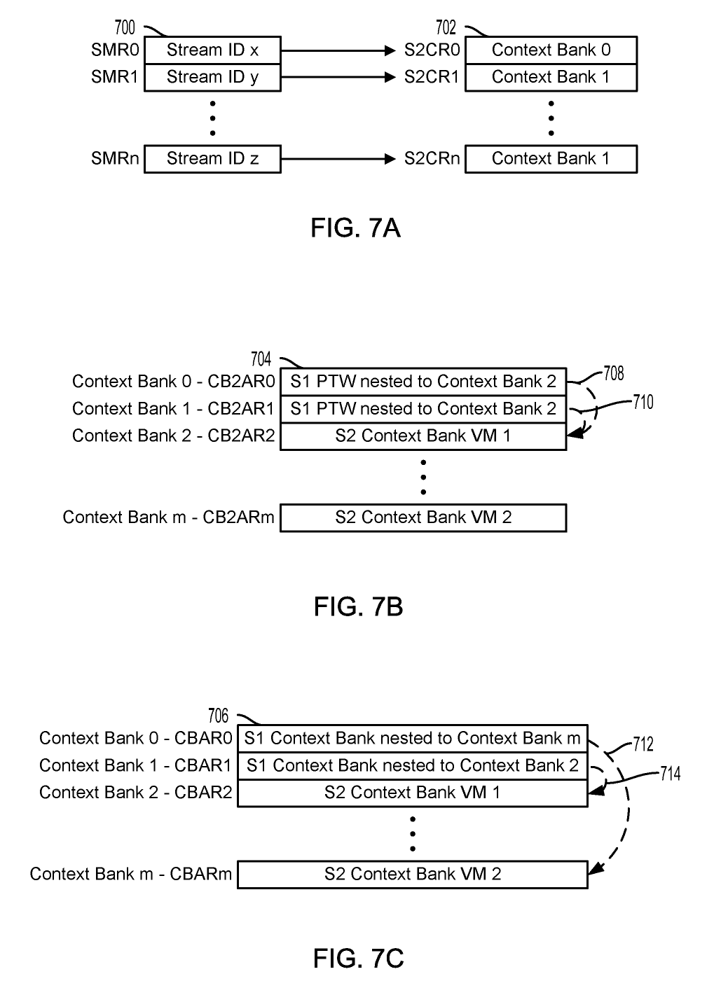

FIGS. 7A-7C illustrate examples of system memory management unit registers according to various aspects. An SMMU (e.g., memory management units 408, 410a, 410b, 410c, 410d in FIG. 4) may include various programmable registers 700, 702, 704, 706, which may be configured to aid the translation of virtual addresses and intermediate physical addresses in various contexts. As discussed herein, a stream identifier may be used to aid in determining the context of an address for translation. A transaction stream may be a sequence of transactions associated with a particular thread of activity for a process. All of the transactions from the same transaction stream may be associated with the same stream identifier, which may be an attribute that is conveyed by the I/O device along with each memory access request. The stream identifier may be used for resolving which translation context the SMMU should use to process the memory access request.

The SMMU may map a memory access request to its corresponding translation context using the data of the registers 700, 702, 704, 706. The register 700 may be a stream match register (SMRn) configured with data for use in determining whether a transaction matches with a group of the registers 702, 704, 706. The register 702 may be a stream to context register (S2CRn) configured with data that may specify an initial translation context to be used in the translation process. The registers 704, 706 may be context bank attribute registers (CBARm,CB2ARm) configured with data that may specify a type of context bank (e.g., a context bank number) and a next stage translation context (e.g., a VM identifier (VMID)).

Using the stream identifier of the memory access request, the SMMU may compare the stream identifier with the data programmed in the stream match registers 700 (e.g., Stream ID x, Stream ID y, Stream ID z). An entry of data of a stream match registers 700 matching the stream identifier may identify a corresponding stream to context register 702 (e.g., SMRO may correspond with S2CR0, SMR1 may correspond with S2CR1, and SMRn may correspond with S2CRn). The stream to context register 702 may contain data pointing to the initial translation context, such as a context bank (e.g., context bank 0 and context bank 1), which may be associated with an entry in a context bank attribute register 704, 706. The context bank attribute register 704 may provide the translation context for translating the virtual address of a memory access request from VM 1 and VM 2 through VM 1. The context banks may be associated with the context bank attribute register 704 for routing the stage 1 translation of the virtual address of the memory access request. For example, context bank 0 in context bank attribute register 704 may contain data that the stage 1 (S1) page table walk (PTW) is nested to context bank 2 of the context bank attribute register 704, and context bank 2 may contain data that the stage 2 context bank is for the VM 1. The SMMU may route the page table walk to translate the virtual address translation through the VM 1. The context bank attribute register 706 may provide the translation context for translating the resulting intermediate physical address through the VM that made the memory access request to access data for the memory access request. The context banks may be associated with the context bank attribute register 706 for routing the stage 2 translation of the intermediate physical address of the memory access request identified from the translations using the context bank attribute register 704. For example, context bank 0 in context bank attribute register 706 may contain data that the stage 1 (S1) context bank is nested to context bank m of the context bank attribute register 706, and context bank m may contain data that the stage 2 (S2) context bank is for the VM 2. The SMMU may route the intermediate physical address translation through the VM 2.

In the example illustrated in FIG. 7B, dashed lines are used to show relationships between the context banks of the context bank attribute register 704 for the various stage translations for translating a virtual address of a memory access request from VM 1 and VM 2 to an intermediate physical address through VM 1. For example, dashed line 708 illustrates that the stage 1 translation context for the stage 1 page table walk associated with context bank 0 in the context bank attribute register 704 may be nested to the stage 2 translation context associated with context bank 2 in the context bank attribute register 704. The stage 2 translation context associated with context bank 2 may specify that VM 1 executes the stage 2 translation. The nesting of the stage 1 translation context to the stage 2 translation context may provide that VM 1 also executes the stage 1 translation. Similarly, dashed line 710 illustrates that the stage 1 translation context for the stage 1 page table walk associated with context bank 1 in the context bank attribute register 704 may be nested to the stage 2 translation context associated with context bank 2 in the context bank attribute register 704. The stage 2 translation context associated with context bank 2 may specify that VM 1 executes the stage 2 translation. The nesting of the stage 1 translation context to the stage 2 translation context may provide that VM 1 also executes the stage 1 translation. Therefore, in both instances of a stream identifier of the memory access request associated with context bank 0 and context bank 1, as illustrated in FIG. 7A, the stage 1 and stage 2 translations for translating the virtual address of the memory access request to an intermediate physical address are executed by VM 1.

In the example illustrated in FIG. 7C, dashed lines are used to show relationships between the context banks of the context bank attribute register 706 for the various stage translations for translating a virtual address of a memory access request from VM 1 and VM 2 to access data associated with the virtual address through the VM that issued the memory access request. The translations using the translation contexts specified in the context bank attribute register 706 may use the intermediate physical address resulting from the example illustrated in FIG. 7B to translate the virtual address to a physical address at which the data is stored. For example, dashed line 712 illustrates that the stage 1 translation context for the virtual address associated with context bank 0 in the context bank attribute register 706 may be nested to the stage 2 translation context associated with context bank m in the context bank attribute register 706. The stage 2 translation context associated with context bank m may specify that VM 2 executes the stage 2 translation. The nesting of the stage 1 translation context to the stage 2 translation context may provide that VM 2 also executes the stage 1 translation. Therefore, for a stream identifier of the memory access request associated with context bank 0, as illustrated in FIG. 7A, the stage 1 and stage 2 translations for translating the virtual address of the memory access request, to access the requested data of the memory access request, are executed by VM 2. Similarly, dashed line 714 illustrates that the stage 1 translation context for the virtual address associated with context bank 1 in the context bank attribute register 706 may be nested to the stage 2 translation context associated with context bank 2 in the context bank attribute register 706. The stage 2 translation context associated with context bank 2 may specify that VM 1 executes the stage 2 translation. The nesting of the stage 1 translation context to the stage 2 translation context may provide that VM 1 also executes the stage 1 translation. Therefore, for a stream identifier of the memory access request associated with context bank 1, as illustrated in FIG. 7A, the stage 1 and stage 2 translations for translating the virtual address of the memory access request, to access the requested data of the memory access request, are executed by VM 1.

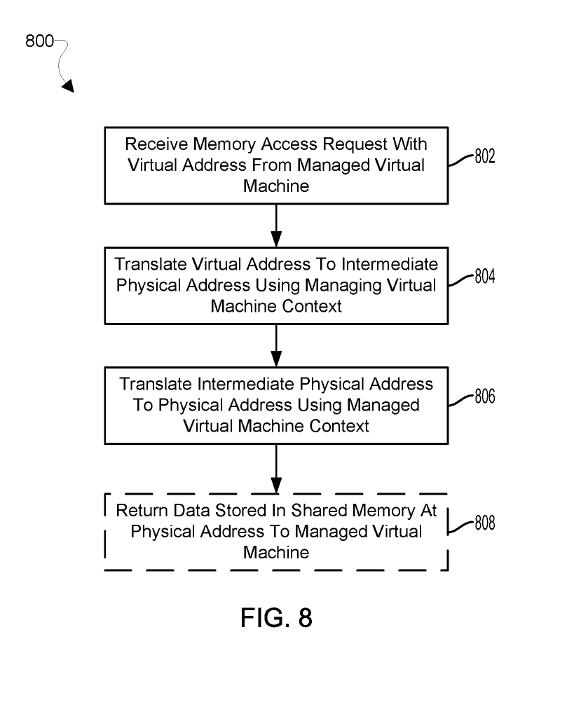

FIG. 8 illustrates a method 800 for implementing managed virtual machine memory access according to an aspect. The method 800 may be implemented in a computing device in software executing in a processor (e.g., the processor 14 in FIGS. 1 and 2 and (e.g., I/O devices 306, 310, 312, 314, 318, 320, 322 in FIG. 3, and processing devices 402, 406a, 406b, 406c, 406d), in general purpose hardware, in dedicated hardware (e.g., memory management units 408, 410a, 410b, 410c, 410d and hypervisor 412 in FIG. 4), or in a combination of a software-configured processor and dedicated hardware, such as a processor executing software within a memory management system that includes other individual components (e.g., memory 16, 24 in FIG. 1, private cache 210, 212, 214, 216, and shared cache 230 in FIG. 2, system cache 302 and RAM 328 in FIG. 3, and physical memory 404 in FIGS. 4 and 6), and various memory/cache controllers. In order to encompass the alternative configurations enabled in various aspects, the hardware implementing the method 800 is referred to herein as a “processing device.”

In block 802, the processing device may receive a memory access request from an I/O device executing processes for a managed virtual machine. In various aspects, the memory access request may include information, such as a type of memory access request (e.g., a read or write memory access request), a virtual address for the memory access request, and/or a stream identifier for the process from which the memory access request originated.

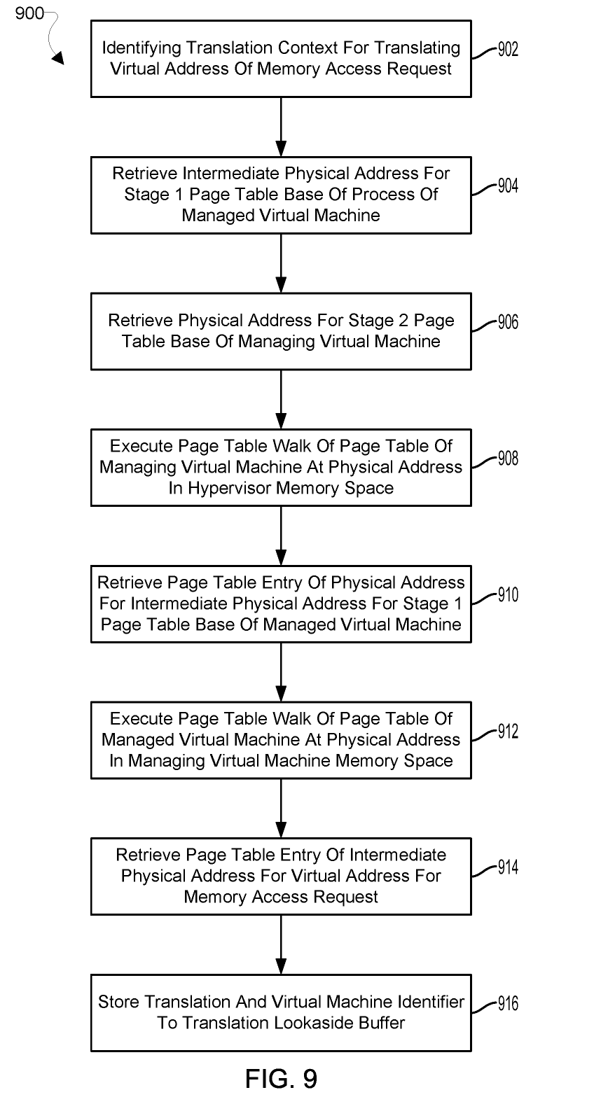

In block 804, the processing device may translate the virtual address of the memory access request to an intermediate physical address using a managing virtual machine context. Translation of the virtual address to the intermediate physical address is discussed in the method 900 described with reference to FIG. 9.

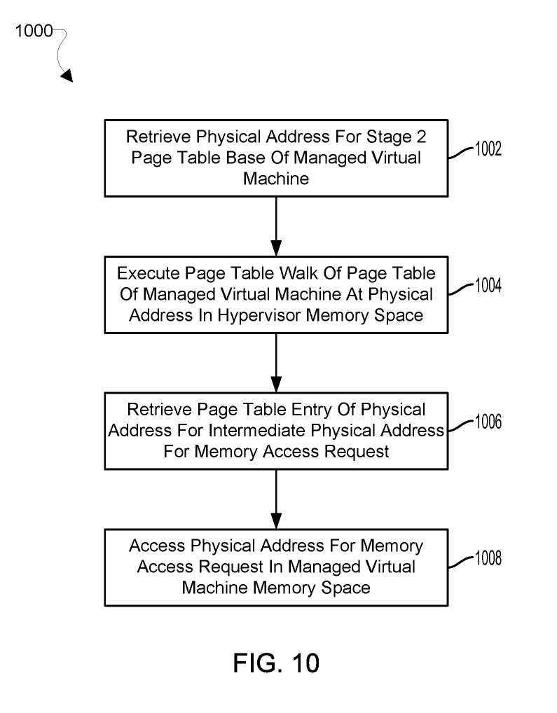

In block 806, the processing device may translate the intermediate physical address to a physical address using a managed virtual machine context. Translation of the intermediate physical address to the physical address is discussed in the method 1000 described with reference to FIG. 10. In optional block 808, the processing device may return data, stored at the physical address corresponding to the virtual address of the memory access request, to the managed virtual machine.

FIG. 9 illustrates a method 900 for implementing managed virtual machine memory access according to an aspect. The method 900 may be implemented in a computing device in software executing in a processor (e.g., the processor 14 in FIGS. 1 and 2 and (e.g., I/O devices 306, 310, 312, 314, 318, 320, 322 in FIG. 3, and processing devices 402, 406a, 406b, 406c, 406d), in general purpose hardware, in dedicated hardware (e.g., memory management units 408, 410a, 410b, 410c, 410d and hypervisor 412 in FIG. 4), or in a combination of a software-configured processor and dedicated hardware, such as a processor executing software within a memory management system that includes other individual components (e.g., memory 16, 24 in FIG. 1, private cache 210, 212, 214, 216, and shared cache 230 in FIG. 2, system cache 302 and RAM 328 in FIG. 3, and physical memory 404 in FIGS. 4 and 6), and various memory/cache controllers. In order to encompass the alternative configurations enabled in the various aspects, the hardware implementing the method 900 is referred to herein as a “processing device.” Further, portions of the methods 800, 900, and 1000 illustrated in FIGS. 8, 9, and 10 may be implemented in response to, as part of, and in parallel with each other.

In block 902, the processing device may identify a translation context for translating the virtual address of the memory access request. In various aspects, the processing device may compare a stream identifier configured to identify the process executed by the I/O device for the managed virtual machine with translation context registers (e.g., registers 700, 702, 704, 706 in FIG. 7). A matching comparison between the stream identifier and the data stored in the translation context registers may identify a translation context for each translation for the memory access request. An initial translation context may be identified to start translation of the virtual address using the managing virtual machine. Subsequent translation contexts for the various translations described herein may stem from the initial translation context and the data stored in and associations between the translation context registers, for example, as described herein with reference to the descriptions of FIGS. 6 and 7.

In block 904, the processing device may retrieve an intermediate physical address for a base address of a stage 1 page table for a process executed by the managed virtual machine. As described herein, the intermediate physical address for a base address of a stage 1 page table may be stored in a register associated with the process executed by the managed virtual machine. In various aspects, a stream identifier correlated with a register or entry in a register may be used to identify the data indicating the intermediate physical address for the base address of a stage 1 page table.

In block 906, the processing device may retrieve a physical address for a base address of a stage 2 page table for the managing virtual machine. In various aspects, a stream identifier correlated with a register or entry in a register may be associated with a translation context that indicates that the base address of a stage 1 page table is to be translated by the managing virtual machine. In various aspects, the physical address of the stage 2 page table for the managing virtual machine may be in a register associated with the process executed by the managed virtual machine and/or associated with the managing virtual machine. In various aspects, the stream identifier correlated with a register or entry in a register may be used to identify the data indicating the physical address for the base address of a stage 2 page table. In various aspects, data stored in the register having the intermediate physical address for the base address of a stage 1 page table may point to the register having the physical address for the base address of a stage 2 page table. In various aspects, the processing device may be configured to check a designated register for the physical address for the base address of a stage 2 page table. In various aspects, the register may be associated with the managing virtual machine and/or a translation context for the managing virtual machine.

In block 908, the processing device may execute a page table walk of a physical memory space. The physical memory space may be allocated to a hypervisor. The physical memory space may include the physical address for the base address of the stage 2 page table. The page table walk may be executed beginning at the physical address for the base address of the stage 2 page table and may walk the stage 2 page table in the physical memory space searching for a page table entry for the address translation of the intermediate physical address for the base address of a stage 1 page table, for the process executed by the managed virtual machine, to a physical address.

In block 910, the processing device may retrieve the page table entry for the address translation of the intermediate physical address for the base address of a stage 1 page table, for the process executed by the managed virtual machine, to a physical address. The physical address may be retrieved from the entry in the page table stored in the physical memory space allocated to the hypervisor and walked by the processing device.

In block 912, the processing device may execute a page table walk of a physical memory space. The physical memory space may be allocated to the managing virtual machine. The physical memory space may include the physical address for the base address of the stage 1 page table for the process executed by the managed virtual machine. The page table walk may be executed beginning at the physical address for the base address of the stage 1 page table and may walk the stage 1 page table in the physical memory space searching for a page table entry for the address translation of the virtual address of the memory access request to an intermediate physical address.

In block 914, the processing device may retrieve the page table entry for the address translation of the virtual address of the memory access request to the intermediate physical address. The intermediate physical address may be retrieved from the entry in the page table stored in the physical memory space allocated to the managing virtual machine and walked by the processing device.

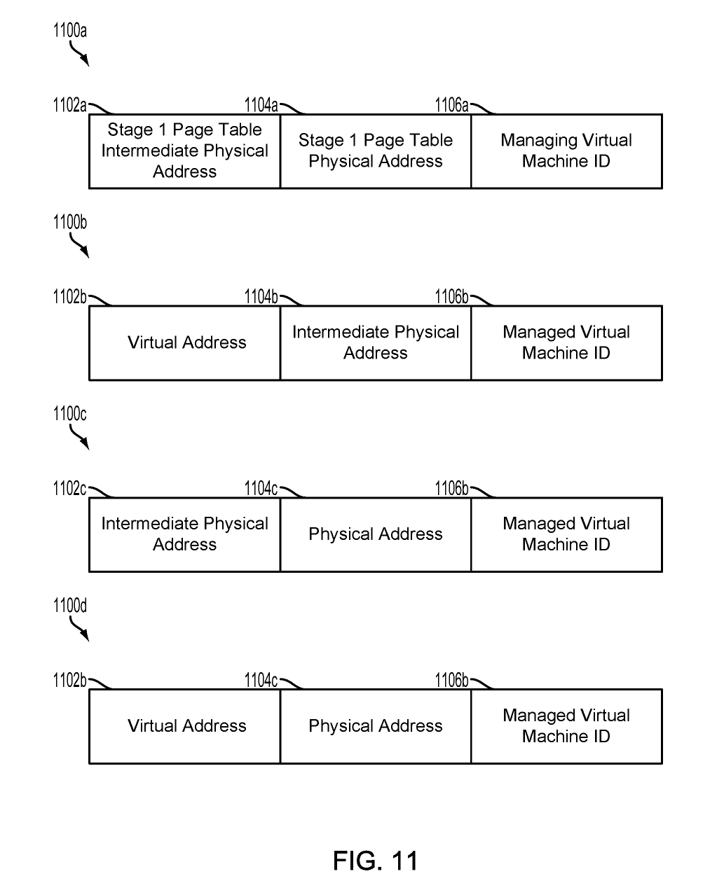

In block 916, the processing device may store the various address translations for translating the virtual address to the physical address in a translation lookaside buffer. The processing device may tag the translation lookaside buffer for each translation with a VM identifier associated with the stored translation. In various aspects, the VM identifier may be stored to the translation lookaside buffer and associated with the stored translation. The VM identifier associated with the stored translation may be for the virtual machine implementing the translation, rather than the virtual machine for which the translation is implemented. In other words, the VM identifiers associated with the stored translation may be the VM identifier matching the VM identifier of the context bank attribute register (e.g., context bank register attribute 704 in FIG. 7B) that may provide the translation context for translating the virtual address of a memory access requests from a first virtual machine and a second virtual machine through the first virtual machine. Future translations of the virtual address may be expedited by retrieving the translation from the translation lookaside buffer by the virtual machine having the associated virtual machine identifier. Tagging of the the translation lookaside buffer for each translation with a VM identifier is described further with reference to FIG. 11.

FIG. 10 illustrates a method 1000 for implementing managed virtual machine memory access according to an aspect. The method 1000 may be implemented in a computing device in software executing in a processor (e.g., the processor 14 in FIGS. 1 and 2 and (e.g., I/O devices 306, 310, 312, 314, 318, 320, 322 in FIG. 3, and processing devices 402, 406a, 406b, 406c, 406d), in general purpose hardware, in dedicated hardware (e.g., memory management units 408, 410a, 410b, 410c, 410d and hypervisor 412 in FIG. 4), or in a combination of a software-configured processor and dedicated hardware, such as a processor executing software within a memory management system that includes other individual components (e.g., memory 16, 24 in FIG. 1, private cache 210, 212, 214, 216, and shared cache 230 in FIG. 2, system cache 302 and RAM 328 in FIG. 3, and physical memory 404 in FIGS. 4 and 6), and various memory/cache controllers. In order to encompass the alternative configurations enabled in the various aspects, the hardware implementing the method 1000 is referred to herein as a “processing device.” Further, portions of the methods 800, 900, and 1000 in FIGS. 8, 9, and 10 may be implemented in response to, as part of, and in parallel with each other.

In block 1002, the processing device may retrieve a physical address for a base address of a stage 2 page table for the managed virtual machine. In various aspects, a stream identifier correlated with a register or entry in a register may be associated with a translation context that indicates that the intermediate physical address is to be translated by the managed virtual machine. In various aspects, the physical address of the stage 2 page table for the managed virtual machine may be in a register associated with the process executed by the managed virtual machine and/or associated with the managed virtual machine. In various aspects, the stream identifier correlated with a register or entry in a register may be used to identify the data indicating the physical address for the base address of a stage 2 page table. In various aspects, data stored in the register having the intermediate physical address for the base address of a stage 1 page table may point to the register having the physical address for the base address of a stage 2 page table. In various aspects, the processing device may be configured to check a designated register for the physical address for the base address of a stage 2 page table. In various aspects, the register may be associated with the managed virtual machine and/or a translation context for the managed virtual machine.

In block 1004, the processing device may execute a page table walk of a physical memory space. The physical memory space may be allocated to the hypervisor. The physical memory space may include the physical address for the base address of the stage 2 page table for the managed virtual machine. The page table walk may be executed beginning at the physical address for the base address of the stage 2 page table and may walk the stage 2 page table in the physical memory space searching for a page table entry for the address translation of the intermediate physical address of the memory access request to a physical address.

In block 1006, the processing device may retrieve the page table entry for the address translation of the intermediate physical address of the memory access request to the physical address. The physical address may be retrieved from the entry in the page table stored in the physical memory space allocated to the hypervisor and walked by the processing device.

In block 1008, the processing device may access the physical address in the physical memory space. The physical memory space may be allocated to the managed virtual machine. In various aspects, accessing the physical address may include an operation, such as a read operation or a write operation, specified by the memory access request.

FIG. 11 illustrates example representations of different stages of translations of different addresses tagged with virtual machine identifiers (IDs) according to various aspects. Various stages of translation of a virtual address to a physical address may be stored by a translation lookaside buffer so that future translations of the virtual address may be expedited by retrieving the translation from the translation lookaside buffer rather than having to access the page tables stored in the physical memory (e.g., physical memory 404 in FIGS. 4 and 6).

A translation lookaside buffer may store a translation in various forms. For example, a stored translation lookaside buffer entry 1100a, 1100b, 1100c, 1100d may include a first address 1102a, 1102b, 1102c, related with a second address 1104a, 1104b, 1104c. The first address may be an address, such as a virtual address 1102b or an intermediate physical address 1102a, 1102c, that a virtual machine is translating. The second address may be an address, such as an intermediate physical address 1104b or a physical address 1104a, 1104c, that the virtual machine is translating to. The stored translation lookaside buffer entry 1100a, 1100b, 1100c, 1100d may include a virtual machine identifier 1106a, 1106b associated with the translation relationship of the first address 1102a, 1102b, 1102c, to the second address 1104a, 1104b, 1104c. The virtual machine identifier 1106a, 1106b may be an identifier for a virtual machine that may access the translation lookaside buffer entry 1100a, 1100b, 1100c, 1100d to use the translation relationship of the first address 1102a, 1102b, 1102c, to the second address 1104a, 1104b, 1104c to implement an address translation.

As discussed herein, various address translations may be implemented by various virtual machines, such as a managing virtual machine and a managed virtual machine, to translate a virtual address 1102b of a memory access request from the managed virtual machine. Such address translations may include the managing virtual machine executing a stage 1 translation of the virtual address 1102b to an intermediate physical address 1104b for the managed virtual machine. As described herein, the stage 1 translation may include multiple translations to retrieve various addresses of page tables used to retrieve the intermediate physical address 1104b associated with the virtual address 1102b. The managing virtual machine may execute a translation for a stage 1 page table intermediate physical address 1102a to retrieve a stage 1 page table physical address 1104a in the physical memory so that the intermediate physical address 1104b associated with the virtual address 1102b may be retrieved from the stage 1 page table in the physical memory by executing a page table walk of the stage 1 page table in the physical memory. The resulting translation of the stage 1 page table intermediate physical address 1102a to retrieve a stage 1 page table physical address 1104a may be stored as a translation lookaside buffer entry 1100a for future translations of the stage 1 page table intermediate physical address 1102a to retrieve a stage 1 page table physical address 1104a. The translation lookaside buffer entry 1100a may associate a managing virtual machine identifier 1106a with the translation. This may enable the managing virtual machine with a atching identifier to access the translation lookaside buffer entry 1100a to execute future translations of the stage 1 page table intermediate physical address 1102a to retrieve a stage 1 page table physical address 1104a without having to execute as many intermediary translations to retrieve the stage 1 page table physical address 1104a.

Similarly, the managing virtual machine and a hypervisor may implement various stage 1 and stage 2 translations to determine the translations between the virtual address 1102b of the memory access request, the intermediate physical address 1104b associated with the virtual address 1102b, and a physical address 1104c associated with the virtual address 1102b and the intermediate physical address 1104b. The resulting translation of the virtual address 1102b to the intermediate physical address 1104b may be stored as a translation lookaside buffer entry 1100b for future stage 1 transactions of the virtual address 1102b. The translation lookaside buffer entry 1100b may associate a managed virtual machine identifier 1106b with the translation. This may enable the managed virtual machine with a matching identifier to access the translation lookaside buffer entry 1100b to execute future stage 1 translations of the virtual address 1102b to the intermediate physical address 1104b without having to execute as many intermediary translations to retrieve the intermediate physical address 1104b, including the translations by the managing virtual machine.

The resulting translation of the intermediate physical address 1102c (which may be the same as the intermediate physical address 1104b) to a physical address 1104c may be stored as a translation lookaside buffer entry 1100c for future stage 2 transactions of the intermediate physical address 1102c. The translation lookaside buffer entry 1100c may associate the managed virtual machine identifier 1106b with the translation. This may enable the managed virtual machine with a matching identifier to access the translation lookaside buffer entry 1100c to execute future stage 2 transactions of the intermediate physical address 1102c to the physical address 1104c without having to execute as many intermediary translations to retrieve the physical address 1104c, including the translations by the managing virtual machine.

The resulting translation of the virtual address 1102b to the physical address 1104c may be stored as a translation lookaside buffer entry 1100d for future stage 1 and stage 2 transactions of the virtual address 1102b. The translation lookaside buffer entry 1100d may associate the managed virtual machine identifier 1106b with the translation. This may enable the managed virtual machine with a matching identifier to access the translation lookaside buffer entry 1100d to execute future stage 1 and stage 2 transactions of the virtual address 1102b to the physical address 1104c without having to execute as many intermediary translations to retrieve the physical address 1104c, including the translations by the managing virtual machine.

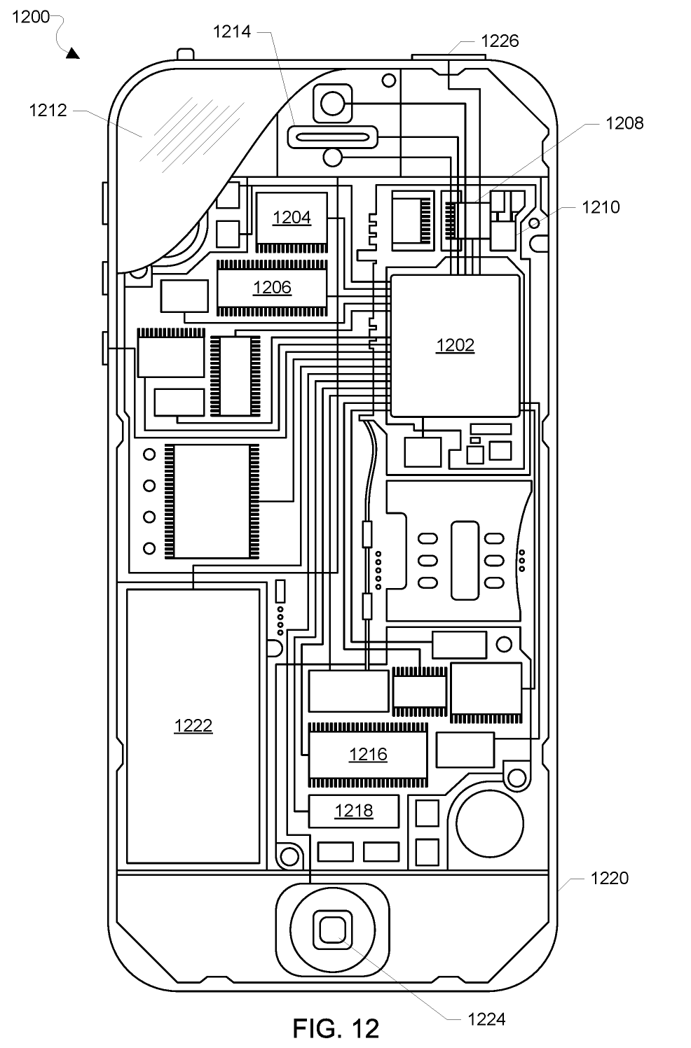

The various aspects (including, but not limited to, aspects described above with reference to FIGS. 1-11) may be implemented in a wide variety of computing systems including mobile computing devices, an example of which suitable for use with the various aspects is illustrated in FIG. 12. The mobile computing device 1200 may include a processor 1202 coupled to a touchscreen controller 1204 and an internal memory 1206. The processor 1202 may be one or more multicore integrated circuits designated for general or specific processing tasks. The internal memory 1206 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1204 and the processor 1202 may also be coupled to a touchscreen panel 1212, such as a resistive-sensing touchscreen, capacitive-sensing touchscreen, infrared sensing touchscreen, etc. Additionally, the display of the computing device 1200 need not have touch screen capability.

The mobile computing device 1200 may have one or more radio signal transceivers 1208 (e.g., Peanut, Bluetooth, ZigBee, Wi-Fi, RF radio) and antennae 1210, for sending and receiving communications, coupled to each other and/or to the processor 1202. The transceivers 1208 and antennae 1210 may be used with the above-mentioned circuitry to implement the various wireless transmission protocol stacks and interfaces. The mobile computing device 1200 may include a cellular network wireless modem chip 1216 that enables communication via a cellular network and is coupled to the processor.

The mobile computing device 1200 may include a peripheral device connection interface 1218 coupled to the processor 1202. The peripheral device connection interface 1218 may be singularly configured to accept one type of connection, or may be configured to accept various types of physical and communication connections, common or proprietary, such as Universal Serial Bus (USB), FireWire, Thunderbolt, or PCIe. The peripheral device connection interface 1218 may also be coupled to a similarly configured peripheral device connection port (not shown).

The mobile computing device 1200 may also include speakers 1214 for providing audio outputs. The mobile computing device 1200 may also include a housing 1220, constructed of a plastic, metal, or a combination of materials, for containing all or some of the components described herein. The mobile computing device 1200 may include a power source 1222 coupled to the processor 1202, such as a disposable or rechargeable battery. The rechargeable battery may also be coupled to the peripheral device connection port to receive a charging current from a source external to the mobile computing device 1200. The mobile computing device 1200 may also include a physical button 1224 for receiving user inputs. The mobile computing device 1200 may also include a power button 1226 for turning the mobile computing device 1200 on and off.

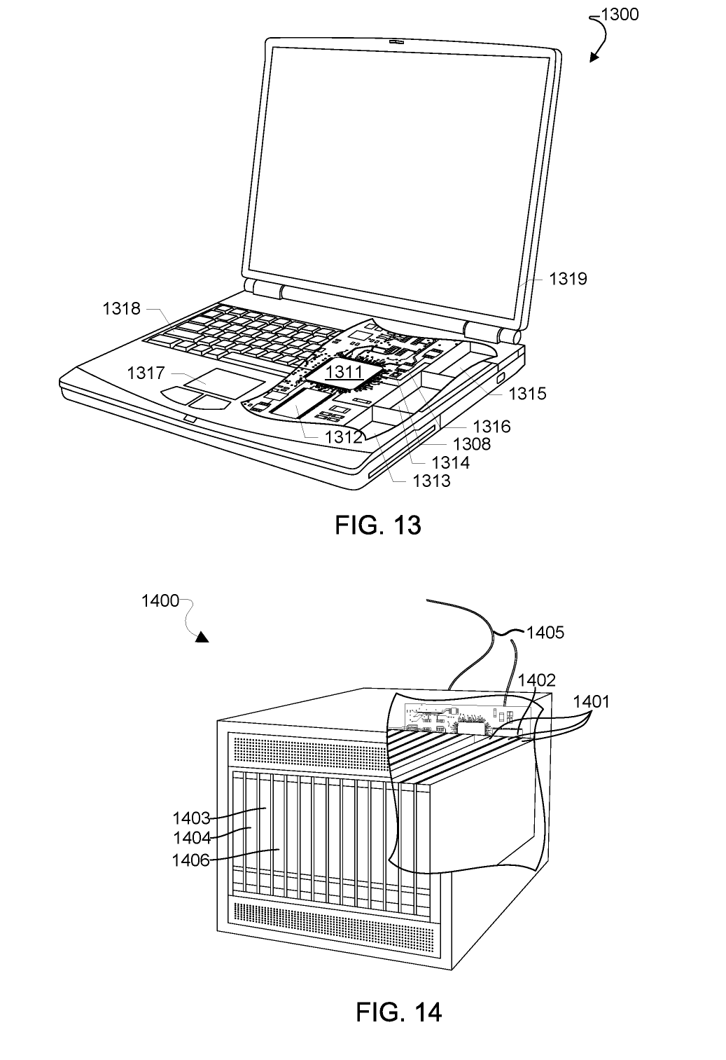

The various aspects (including, but not limited to, aspects described above with reference to FIGS. 1-11) may be implemented in a wide variety of computing systems include a laptop computer 1300 an example of which is illustrated in FIG. 13. Many laptop computers include a touchpad touch surface 1317 that serves as the computer's pointing device, and thus may receive drag, scroll, and flick gestures similar to those implemented on computing devices equipped with a touch screen display and described above. A laptop computer 1300 will typically include a processor 1311 coupled to volatile memory 1312 and a large capacity nonvolatile memory, such as a disk drive 1313 of Flash memory. Additionally, the computer 1300 may have one or more antenna 1308 for sending and receiving electromagnetic radiation that may be connected to a wireless data link and/or cellular telephone transceiver 1316 coupled to the processor 1311. The computer 1300 may also include a floppy disc drive 1314 and a compact disc (CD) drive 1315 coupled to the processor 1311. In a notebook configuration, the computer housing includes the touchpad 1317, the keyboard 1318, and the display 1319 all coupled to the processor 1311. Other configurations of the computing device may include a computer mouse or trackball coupled to the processor (e.g., via a USB input) as are well known, which may also be used in conjunction with the various aspects.

The various aspects (including, but not limited to, aspects described above with reference to FIGS. 1-11) may also be implemented in fixed computing systems, such as any of a variety of commercially available servers. An example server 1400 is illustrated in FIG. 14. Such a server 1400 typically includes one or more multicore processor assemblies 1401 coupled to volatile memory 1402 and a large capacity nonvolatile memory, such as a disk drive 1404. As illustrated in FIG. 14, multicore processor assemblies 1401 may be added to the server 1400 by inserting them into the racks of the assembly. The server 1400 may also include a floppy disc drive, compact disc (CD) or digital versatile disc (DVD) disc drive 1406 coupled to the processor 1401. The server 1400 may also include network access ports 1403 coupled to the multicore processor assemblies 1401 for establishing network interface connections with a network 1405, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects and implementations without departing from the scope of the claims. Thus, the present disclosure is not intended to be limited to the aspects and implementations described herein, but is to be accorded the widest scope consistent with the following claims and the principles and novel features disclosed herein.

What is claimed is:

1. A method of managed virtual machine memory access on a computing device, comprising:
receiving a memory access request from a managed virtual machine having a virtual address;
retrieving a first physical address for a stage 2 page table for a managing virtual machine, wherein the stage 2 page table for the managing virtual machine is stored in a physical memory space allocated to a hypervisor;
retrieving a second physical address from an entry of the stage 2 page table for the managing virtual machine for a stage 1 page table for a process executed by the managed virtual machine, wherein the second physical address is for a physical memory space allocated to the managing virtual machine, and the stage 1 page table for the process executed by the managed virtual machine is stored in the physical memory space allocated to the managing virtual machine; and
retrieving a first intermediate physical address from an entry of the stage 1 page table for the process executed by the managed virtual machine for a translation of the virtual address.

2. The method of claim 1, wherein:
retrieving a second physical address from an entry of the stage 2 page table comprises executing a page table walk of the stage 2 page table for the managing virtual machine in the physical memory space allocated to the hypervisor for the second physical address; and
retrieving a first intermediate physical address from an entry of the stage 1 page table comprises executing a page table walk of the stage 1 page table for the process executed by the managed virtual machine in the physical memory space allocated to the managing virtual machine for the first intermediate physical address.

3. The method of claim 1, wherein retrieving a first physical address for a stage 2 page table for a managing virtual machine comprises retrieving the first physical address from a first register associated with a translation context for the managing virtual machine, and
the method further comprising retrieving a second intermediate physical address for the stage 1 page table for the process executed by the managed virtual machine from a second register associated with the process executed by the managed virtual machine.

4. The method of claim 1, further comprising:
retrieving a third physical address for a stage 2 page table for the managed virtual machine, wherein the third physical address is for the physical memory space allocated to the hypervisor, and the stage 2 page table for the managed virtual machine is stored in the physical memory space allocated to the hypervisor;
executing a page table walk of the stage 2 page table for the managed virtual machine in the physical memory space allocated to the hypervisor for a fourth physical address for a translation of the first intermediate physical address; and
retrieving the fourth physical address from an entry of the stage 2 page table for the managed virtual machine.

5. The method of claim 1, further comprising identifying a plurality of translation contexts for translating the virtual address of the memory access request.

6. The method of claim 5, wherein identifying a plurality of initial translation contexts comprises:
comparing a stream identifier of the memory access request configured to identify the process executed by the managed virtual machine with a stream identifier stored in a first register; and
identifying a translation context of the managing virtual machine for translating the virtual address to the second intermediate physical address from data stored in a first plurality of registers associated with the first register, wherein at least one of the first plurality of registers specifies a virtual machine identifier of the managing virtual machine.

7. The method of claim 6, wherein identifying a plurality of initial translation contexts comprises identifying a translation context of the managed virtual machine for translating the virtual address to a third physical address from data stored in a second plurality of registers associated with the first register, wherein at least one of the second plurality of registers specifies a virtual machine identifier of the managed virtual machine.

8. The method of claim 1, further comprising:
storing a translation of the virtual address to the first intermediate physical address to a translation lookaside buffer; and
associating the stored translation with a virtual machine identifier of the managed virtual machine in the translation lookaside buffer.

9. A computing device, comprising:
a physical memory having a physical memory space allocated to a hypervisor and a physical memory space allocated to a managing virtual machine;
a processor configured to execute the managing virtual machine and a managed virtual machine, and configured to perform operations comprising:
receiving a memory access request from the managed virtual machine having a virtual address;
retrieving a first physical address for a stage 2 page table for the managing virtual machine, wherein the stage 2 page table for the managing virtual machine is stored in the physical memory space allocated to the hypervisor;
retrieving a second physical address from an entry of the stage 2 page table for the managing virtual machine for a stage 1 page table for a process executed by the managed virtual machine, wherein the second physical address is for the physical memory space allocated to the managing virtual machine and the stage 1 page table for the process executed by the managed virtual machine is stored in the physical memory space allocated to the managing virtual machine; and
retrieving a first intermediate physical address from an entry of the stage 1 page table for the process executed by the managed virtual machine for a translation of the virtual address.

10. The computing device of claim 9, wherein the processor is configured to perform operations such that:
retrieving a second physical address from an entry of the stage 2 page table comprises executing a page table walk of the stage 2 page table for the managing virtual machine in the physical memory space allocated to the hypervisor for the second physical address; and
retrieving a first intermediate physical address from an entry of the stage 1 page table comprises executing a page table walk of the stage 1 page table for the process executed by the managed virtual machine in the physical memory space allocated to the managing virtual machine for the first intermediate physical address.

11. The computing device of claim 9, further comprising:
a first register associated with a translation context for the managing virtual machine configured to store the first physical address; and
a second register associated with the process executed by the managed virtual machine configured to store a second intermediate physical address,
wherein the processor is configured to perform operations such that retrieving a first physical address for a stage 2 page table for the managing virtual machine comprises retrieving the first physical address from the first register, and
wherein the processor is configured to perform operations further comprising retrieving the second intermediate physical address for the stage 1 page table for the process executed by the managed virtual machine from the second register.

12. The computing device of claim 9, wherein the processor is configured to perform operations further comprising:
retrieving a third physical address for a stage 2 page table for the managed virtual machine, wherein the third physical address is for the physical memory space allocated to the hypervisor and the stage 2 page table for the managed virtual machine is stored in the physical memory space allocated to the hypervisor;
executing a page table walk of the stage 2 page table for the managed virtual machine in the physical memory space allocated to the hypervisor for a fourth physical address for a translation of the first intermediate physical address; and
retrieving the fourth physical address from an entry of the stage 2 page table for the managed virtual machine.

13. The computing device of claim 9, wherein the processor is configured to perform operations further comprising identifying a plurality of translation contexts for translating the virtual address of the memory access request.

14. The computing device of claim 13, further comprising:
a first register configured to store a stream identifier; and
a first plurality of registers associated with the first register, wherein at least one of the first plurality of registers specifies a virtual machine identifier of the managing virtual machine,
wherein the processor is configured to perform operations such that identifying a plurality of initial translation contexts comprises:
comparing a stream identifier of the memory access request configured to identify the process executed by the managed virtual machine with the stream identifier stored in the first register; and
identifying a translation context of the managing virtual machine for translating the virtual address to the second intermediate physical address from data stored in the first plurality of registers associated with the first register.

15. The computing device of claim 14, further comprising a second plurality of registers associated with the first register, wherein at least one of the second plurality of registers specifies a virtual machine identifier of the managed virtual machine,
wherein the processor is configured to perform operations such that identifying a plurality of initial translation contexts comprises identifying a translation context of the managed virtual machine for translating the virtual address to a third physical address from data stored in the second plurality of registers associated with the first register.

16. The computing device of claim 9, further comprising a translation lookaside buffer,
wherein the processor is configured to perform operations further comprising:
storing a translation of the virtual address to the first intermediate physical address to the translation lookaside buffer; and
associating the stored translation with a virtual machine identifier of the managed virtual machine in the translation lookaside buffer.

17. A computing device, comprising:
means for receiving a memory access request from a managed virtual machine having a virtual address;
means for retrieving a first physical address for a stage 2 page table for a managing virtual machine, wherein the stage 2 page table for the managing virtual machine is stored in a physical memory space allocated to a hypervisor;
means for retrieving a second physical address from an entry of the stage 2 page table for the managing virtual machine for a stage 1 page table for a process executed by the managed virtual machine, wherein the second physical address is for a physical memory space allocated to the managing virtual machine and the stage 1 page table for the process executed by the managed virtual machine is stored in the physical memory space allocated to the managing virtual machine; and
means for retrieving a first intermediate physical address from an entry of the stage 1 page table for the process executed by the managed virtual machine for a translation of the virtual address.

18. The computing device of claim 17, wherein:
means for retrieving a second physical address from an entry of the stage 2 page table comprises means for executing a page table walk of the stage 2 page table for the managing virtual machine in the physical memory space allocated to the hypervisor for the second physical address; and
means for retrieving a first intermediate physical address from an entry of the stage 1 page table comprises means for executing a page table walk of the stage 1 page table for the process executed by the managed virtual machine in the physical memory space allocated to the managing virtual machine for the first intermediate physical address.

19. The computing device of claim 17, wherein means for retrieving a first physical address for a stage 2 page table for a managing virtual machine comprises means for retrieving the first physical address from a first register associated with a translation context for the managing virtual machine,
the computing device further comprising means for retrieving a second intermediate physical address for the stage 1 page table for the process executed by the managed virtual machine from a second register associated with the process executed by the managed virtual machine.

20. The computing device of claim 17, further comprising:
means for retrieving a third physical address for a stage 2 page table for the managed virtual machine, wherein the third physical address is for the physical memory space allocated to the hypervisor and the stage 2 page table for the managed virtual machine is stored in the physical memory space allocated to the hypervisor;
means for executing a page table walk of the stage 2 page table for the managed virtual machine in the physical memory space allocated to the hypervisor for a fourth physical address for a translation of the first intermediate physical address; and
means for retrieving the fourth physical address from an entry of the stage 2 page table for the managed virtual machine.

21. The computing device of claim 17, further comprising means for identifying a plurality of translation contexts for translating the virtual address of the memory access request comprising:
means for comparing a stream identifier of the memory access request configured to identify the process executed by the managed virtual machine with a stream identifier stored in a first register; and
means for identifying a translation context of the managing virtual machine for translating the virtual address to the second intermediate physical address from data stored in a first plurality of registers associated with the first register, wherein at least one of the first plurality of registers specifies a virtual machine identifier of the managing virtual machine.

22. The computing device of claim 21, wherein means for identifying a plurality of initial translation contexts further comprises means for identifying a translation context of the managed virtual machine for translating the virtual address to a third physical address from data stored in a second plurality of registers associated with the first register, wherein at least one of the second plurality of registers specifies a virtual machine identifier of the managed virtual machine.

23. The computing device of claim 17, further comprising:
means for storing a translation of the virtual address to the first intermediate physical address to a translation lookaside buffer; and
means for associating the stored translation with a virtual machine identifier of the managed virtual machine in the translation lookaside buffer.

24. A non-transitory processor-readable storage medium having stored thereon processor-executable instructions configured to cause a processor of a computing device to perform operations comprising:
receiving a memory access request from a managed virtual machine having a virtual address;
retrieving a first physical address for a stage 2 page table for a managing virtual machine, wherein the stage 2 page table for the managing virtual machine is stored in a physical memory space allocated to a hypervisor;
retrieving a second physical address from an entry of the stage 2 page table for the managing virtual machine for a stage 1 page table for a process executed by the managed virtual machine, wherein the second physical address is for a physical memory space allocated to the managing virtual machine and the stage 1 page table for the process executed by the managed virtual machine is stored in the physical memory space allocated to the managing virtual machine; and
retrieving a first intermediate physical address from an entry of the stage 1 page table for the process executed by the managed virtual machine for a translation of the virtual address.

25. The non-transitory processor-readable storage medium of claim 24, wherein the stored processor-executable instructions are configured to cause a processor of a computing device to perform operations such that:
retrieving a second physical address from an entry of the stage 2 page table comprises executing a page table walk of the stage 2 page table for the managing virtual machine in the physical memory space allocated to the hypervisor for the second physical address; and
retrieving a first intermediate physical address from an entry of the stage 1 page table comprises executing a page table walk of the stage 1 page table for the process executed by the managed virtual machine in the physical memory space allocated to the managing virtual machine for the first intermediate physical address.

26. The non-transitory processor-readable storage medium of claim 24, wherein the stored processor-executable instructions are configured to cause a processor of a computing device to perform operations such that retrieving a first physical address for a stage 2 page table for a managing virtual machine comprises retrieving the first physical address from a first register associated with a translation context for the managing virtual machine, and
wherein the stored processor-executable instructions are configured to cause a processor of a computing device to perform operations further comprising retrieving a second intermediate physical address for the stage 1 page table for the process executed by the managed virtual machine from a second register associated with the process executed by the managed virtual machine.

27. The non-transitory processor-readable storage medium of claim 24, wherein the stored processor-executable instructions are configured to cause a processor of a computing device to perform operations further comprising:
retrieving a third physical address for a stage 2 page table for the managed virtual machine, wherein the third physical address is for the physical memory space allocated to the hypervisor and the stage 2 page table for the managed virtual machine is stored in the physical memory space allocated to the hypervisor;
executing a page table walk of the stage 2 page table for the managed virtual machine in the physical memory space allocated to the hypervisor for a fourth physical address for a translation of the first intermediate physical address; and
retrieving the fourth physical address from an entry of the stage 2 page table for the managed virtual machine.

28. The non-transitory processor-readable storage medium of claim 24, wherein the stored processor-executable instructions are configured to cause a processor of a computing device to perform operations further comprising identifying a plurality of translation contexts for translating the virtual address of the memory access request by:
comparing a stream identifier of the memory access request configured to identify the process executed by the managed virtual machine with a stream identifier stored in a first register; and
identifying a translation context of the managing virtual machine for translating the virtual address to the second intermediate physical address from data stored in a first plurality of registers associated with the first register, wherein at least one of the first plurality of registers specifies a virtual machine identifier of the managing virtual machine.

29. The non-transitory processor-readable storage medium of claim 28, wherein the stored processor-executable instructions are configured to cause a processor of a computing device to perform operations such that identifying a plurality of initial translation contexts comprises identifying a translation context of the managed virtual machine for translating the virtual address to a third physical address from data stored in a second plurality of registers associated with the first register, wherein at least one of the second plurality of registers specifies a virtual machine identifier of the managed virtual machine.

30. The non-transitory processor-readable storage medium of claim 24, wherein the stored processor-executable instructions are configured to cause a processor of a computing device to perform operations further comprising:
storing a translation of the virtual address to the first intermediate physical address to a translation lookaside buffer; and
associating the stored translation with a virtual machine identifier of the managed virtual machine in the translation lookaside buffer.
